(19) United States
(12) Patent Application Publication
(10) Pub. No.: US 2010/0236883 A1
(43) Pub. Date: Sep. 23, 2010

(54) PNEUMATIC CONSTRICTING DRUM BRAKE ASSEMBLY

(75) Inventors: Gerald M. Szpak, North Royalton, OH (US); Philip Simons, Lorain, OH (US); Kurt W. McClain, North Olmsted, OH (US)

Correspondence Address: FAY SHARPE LLP, 1228 Euclid Avenue, 5th Floor, The Halle Building, Cleveland, OH, 44115, US

(73) Assignee: Eaton Corporation

(21) Appl. No.: 12/726,007

(22) Filed: Mar. 17, 2010

Related U.S. Application Data
(60) Provisional application No. 61/161,095, filed on Mar. 18, 2009.

(51) Int. Cl. F16D 49/14; B23P 11/00

(52) U.S. Cl. 188/77 W; 29/428

(57) ABSTRACT

A pneumatic constricting drum brake with seals attached to axially opposite sides of the hub of the rotating drum with wiper portions of the seals rotatably contacting correspondingly located stationary sealing surfaces on the housing for sealing the hub. At least one of the housing sealing surfaces includes a bearing mount.

### BACKGROUND

Problems have been encountered in service with pneumatic drum brakes and particularly pneumatic drum brakes having the inflatable tube disposed about the brake drum in keeping brake dust from entering the central hub region of the rotating drum where a mounting bearing is typically located.

### SUMMARY

The present disclosure describes a pneumatically operated constricting drum brake with seals attached to the hub of the rotating drum and rotatably contacting stationary sealing surfaces on the housing disposed on axially opposite sides of the hub for sealing the interior of the hub of the rotating drum from exterior contaminants such as brake dust. At least one of the stationary sealing surfaces contains a bearing mount such as the exemplary illustrated adaptor ring.

### BRIEF DESCRIPTION OF THE DRAWINGS

FIG. 1 is a side elevation view of the brake assembly of the present disclosure showing a cover plate in place;

FIG. 2 is a sectional view along section-indicating lines B-B of the brake of FIG. 1;

FIG. 3 is an exploded view of the brake assembly of FIG. 1;

FIG. 4 is a view of a portion of FIG. 2 showing the brake in the unactuated condition; and,

FIG. 5 is a view similar to FIG. 4 showing the brake in the actuated condition.

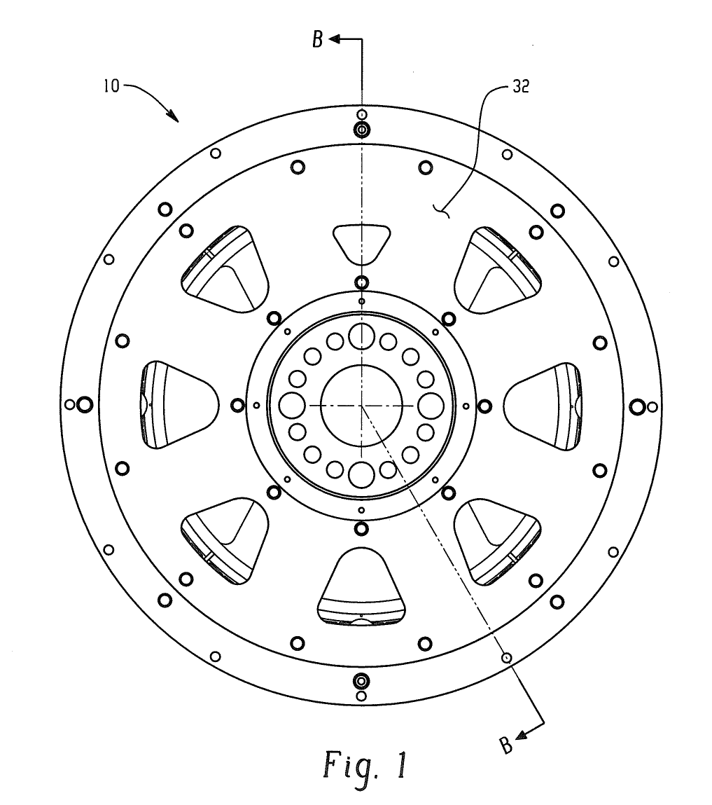

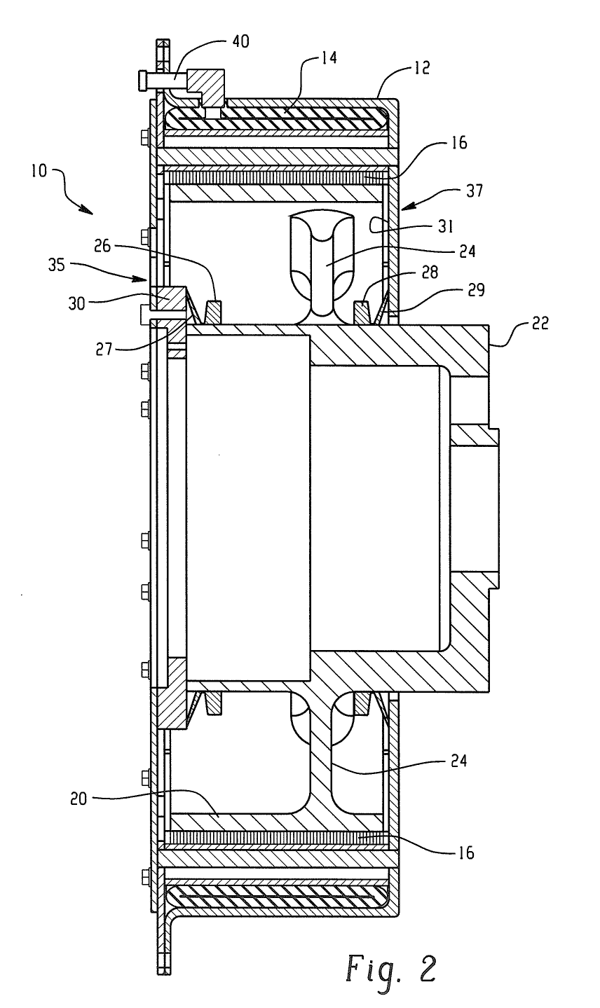

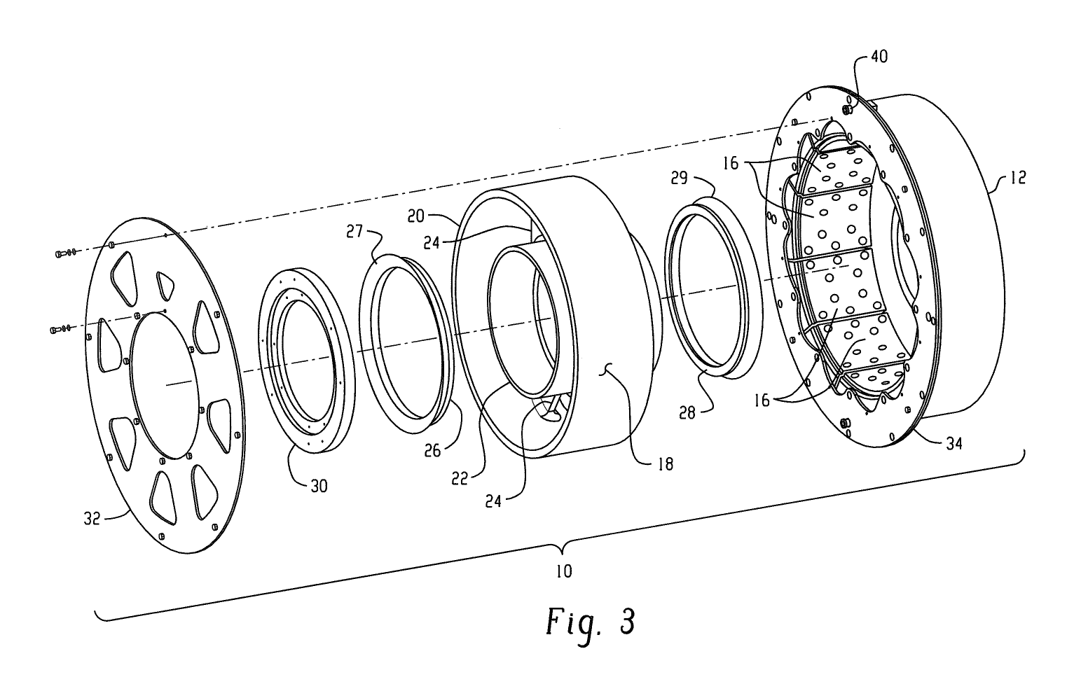

### DETAILED DESCRIPTION

The drawings illustrate the brake assembly generally at 10 with stationary brake element or housing 12 having, in the exemplary illustrated version, a cylindrical cup shaped configuration which contains an inflatable in the form of an annular tube 14 disposed about the interior of the housing; and, tube 14 surrounds an annular array of brake elements 16 disposed within the housing. Drum 20 has an inner annular hub 22 supported by spokes 24 and the hub has a hollow interior.

Upon inflation, tube 14 expands causing elements 16 to be constricted or moved radially inwardly and causes the radially inner surfaces to frictionally engage the outer surface or circumference 18 of rotating drum 20 for effecting braking action.

A pair of annular seals 26, 28 are disposed, one on each axially opposite side of the hub 22 of the rotating drum and are secured thereon for rotation therewith. In the exemplary version illustrated, the seals 26, 28 each include a relatively thin lip or wiper portion 27, 29 provided respectively thereon; and, the wipers 27, 29 may be formed integrally therewith. Seals 24, 26 may be formed of any suitable material, as, for example elastomeric material. The wipers 27, 29 operative respectively to contact in rotary sealing engagement stationary sealing surfaces 30, 31 provided on radially inwardly extending portions indicated generally at 35, 37 the housing correspondingly located. At least one of the radially inwardly extending portions 35 providing surface 30 may comprise a bearing mount such as the exemplary illustrated adaptor ring. It will be understood that the ring 30 is adapted for receiving a mounting bearing (not shown) for the hub 22.

A protective cover 32 is attached to a flange 34 on the housing 12. In the exemplary version illustrated, bearing mount/seal adaptor ring 30 is mounted on the housing cover 32; however, other arrangements for providing a stationary sealing surface for seal ring 26 may be provided, such as, forming a bearing mount integral with the cover 32.

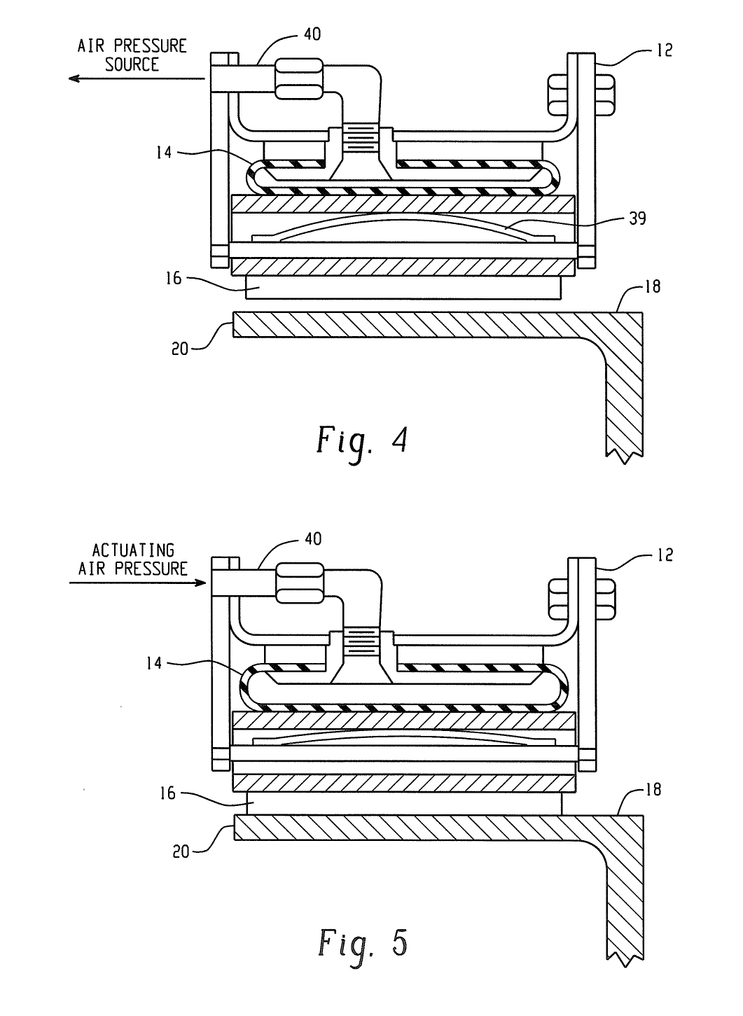

In operation, upon inflation of the annular tube 14 through the air supply connection 40, the annular tube 14 causes brake elements 16 to move radially inwardly, or to constrict, as shown in FIG. 5, against the outer surface 18 of the brake drum. In the exemplary version illustrated in FIGS. 4 and 5, a release spring(s) 39 is/are incorporated between inflatable tube 14 and brake element 16.

The drum brake of the present invention thus provides a single, relatively low cost technique for sealing the hub interior, and any bearing therein, from exterior contaminants such as brake dust. Rotary seals are provided on axially opposite sides of the hub and contact correspondingly located stationary surfaces provided on the housing to effect rotary sealing of the hub. At least one of the stationary sealing surfaces includes a bearing mount; and, the bearing mount may be provided on a cover for the housing.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A pneumatic constricting drum brake comprising:
(a) a housing with an annular array of brake elements operably disposed therein for radial movement;
(b) a brake drum disposed for rotary movement with respect to the housing, the drum having an annular hub and an annular braking surface disposed radially outwardly of the hub about the outer periphery;
(c) an inflatable disposed between the housing and brake elements and operable upon inflation to move the brake elements into contact with the braking surface; and,
(d) an annular seal disposed on each of opposite axial ends of the hub for rotation therewith, wherein the housing includes a plurality of spaced sealing surfaces each contacting one of said annular seals for sealing the interior of the hub.

2. The drum brake defined in claim 1, wherein the braking surface comprises the outer circumference of the drum.

3. The drum brake defined in claim 1, wherein the inflatable has an annular tubular configuration.

4. The drum brake defined in claim 1, wherein the annular seals include elastomeric material

5. The drum brake defined in claim 1, wherein one of said plurality of housing sealing surfaces is formed on a bearing mounting ring disposed on the housing.

6. The drum brake defined in claim 5, wherein the bearing mounting ring is provided with a cover plate.

7. The drum brake defined in claim 1, wherein the housing includes a cover plate with one of the housing sealing surfaces provided thereon.

8. The drum brake defined in claim 1, wherein the annular seals include a relatively thin annular wiper.

9. A method of making a drum brake comprising:
(a) providing a housing;
(b) disposing a brake drum with a hub and a radially outer circumferential braking surface for rotation on the housing;
(c) disposing an annular array of brake elements about the outer circumference of the drum for radial movement with respect thereto;
(d) disposing an inflatable between the housing and the brake elements and upon inflation, moving the elements into contact with the outer circumference of the drum;
(e) disposing annular seals on axially opposite sides of the hub;
(f) providing sealing surfaces on the housing on axially opposite sides of the hub; and,
(g) contacting the housing sealing surfaces with the annular seals and effecting rotary sealing about the hub.

10. The method defined in claim 9, wherein the step of contacting the housing sealing surfaces with annular seals includes forming relatively thin wiper portions on the seals and rotationally wiping the housing sealing surfaces.

11. The method defined in claim 9, wherein the step of providing sealing surfaces on the housing includes providing a bearing mounting ring.

12. The method defined in claim 9, wherein the step of disposing an inflatable includes disposing an annular inflatable tube.

13. The method defined in claim 12, wherein the step of disposing an annular inflatable tube includes forming a tube of elastomeric material.

14. The method defined in claim 9, wherein the step of providing a housing includes providing a cylindrical cup shaped member; and, the step of providing sealing surfaces on the housing includes attaching a cover on the housing and disposing an annular bearing mount ring on the cover.
